(19) United States
(12) Patent Application Publication
(10) Pub. No.: US 2004/0063860 A1
(43) Pub. Date: Apr. 1, 2004

(54) Polymeric fibres

(76) Inventors: Nicholas J. Marston, Cleveland (GB); Mark Davies, Cleveland (GB); John R. Oliver, Yarm (GB)

Correspondence Address: MOORE & VAN ALLEN, PLLC, 2200 W MAIN STREET, SUITE 800, DURHAM, NC, 27705, US

(21) Appl. No.: 10/470,854

(22) PCT Filed: Feb. 1, 2002
(86) PCT No.: PCT/GB02/00455

(30) Foreign Application Priority Data
Feb. 2, 2001 (GB) 0102658.2

(51) Int. Cl. C08L 33/04

(52) U.S. Cl. 525/222

(57) ABSTRACT

A composition comprising a polyester and an acrylic polymer, wherein the acrylic polymer has a thermal degradation temperature of less than or equal to 295° C.

The present invention relates to a polymeric composition and a method of producing a polymeric composition, in particular a composition including a polyester and an additive polymer, and a method for producing a polymeric fibre. In particular, although not exclusively, the invention relates to a method for producing a polymeric fibre by a high speed spinning process.

Various methods for spinning polymer mixtures are known. Typically, these methods focus on increasing the productivity and profitability of the spinning process by striking a balance between increasing the speed of taking up the spun yarn and the extent of the residual elongation of the resultant yarn. If the speed of taking up the spun yarn is increased then the amount of melt extruded from a spinneret is typically increased. However, increasing the take up speed typically enhances the molecular orientation of the spun yarn which typically results in a reduction of the residual elongation of the resultant undrawn yarn. Consequently, the efficiency of a subsequent drawing or draw texturizing step may be reduced as the spun yarn typically possesses a lower elongation at break compared to a yarn which is spun at a lower speed.

Attention has therefore been focussed on spinning polymeric mixtures (i.e. a polymer and additive polymer) to form synthetic fibres that possess a higher elongation at break in the strand at a particular spinning speed compared to the polymer itself which has not been modified by an additive polymer. Consequently, a higher stretching ratio for production of the final yarn is said to be possible thereby resulting in a higher productivity of the spinning unit.

It is also recognised that the productivity of the spinning process depends on other factors such as: the thermal stability of the polymeric mixture and the resulting yarn; the availability and cost of the additives; the requirement for complex and expensive high speed production facilities; and the ease by which the spun yarn may be subjected to secondary processes, such as drawing and draw texturizing.

A particular technical problem associated with processing and spinning a polymeric mixture comprising a polyester and a polymer additive, is the influence of the additive polymer upon the thermal stability of the polymeric mixture during processing and the resultant fibre product. Typically, the required processing temperatures of a polyester is considerably higher than that necessary to process the additive polymer. Consequently, the additive material may degrade during processing, resulting in the production of volatile species, thereby lowering the overall efficiency of the spinning process and having a detrimental effect upon the final product. Degradation of the additive polymer may adversely affect the thermal stability (e.g. lower the thermal stability), the mechanical properties and the appearance of the polymeric mixture and the product yarn. In particular, degradation of the additive material may produce a discoloured product yarn which would render the yarns sub-standard and/or would necessitate correction during dyeing. Suitably, the overall effect resulting from the thermal instability of the additive polymer and/or the polymeric mixture is a decrease in the overall efficiency of the yarn producing process.

The present invention therefore seeks to solve the aforementioned problems associated with the production of fibres from a polyester, in particular a polyester including an additive polymer.

According to a first aspect, the present invention provides a composition comprising a polyester and an acrylic polymer, wherein the acrylic polymer has a thermal degradation temperature of less than or equal to 295° C.

Such a composition is referred to hereinafter as the composition of the present invention

The composition of the present invention seeks to solve the aforementioned technical problems relating to the production of polymeric fibre yarns, particularly polyester fibre yarns. In particular, the fibres produced from the composition of the present invention may be suitable for stretch texturizing and the acrylic polymer of the composition of the present invention is typically inexpensive to produce. Suitably, the composition of the present invention may be spun at increased take up speeds to produce a fibre having an increased elongation at break compared to the polyester alone not including the acrylic polymer. These factors may result in an overall increase in productivity of a process for forming a fibre from the composition of the present invention compared to the unmodified polyester not including the acrylic polymer. Moreover, the composition of the present invention and/or the resultant fibre formed therefrom may have a thermal stability that is similar to that of the unmodified polyester not including the acrylic polymer. Thus thermal degradation of the composition of the present invention may be avoided or lessened during a fibre forming process thereby resulting in an increase in the overall efficiency of a yarn producing process. Moreover, the composition of the present invention may be thermoplastically processed under conditions employed for the unmodified polyester thereby negating the need to modify equipment for processing the composition of the present invention.

By the term “thermal degradation temperature” we mean the temperature above 135° C. at which the acrylic polymer must be heated in accordance with the thermogravimetric procedures described herein, so that the weight of the acrylic polymer decreases by greater than or equal to 1% by weight based on the original weight of the acrylic polymer measured at 135° C. Suitably, the acrylic polymer is heated at a rate of 5° C. per minute.

Suitably, the “thermal degradation temperature” of an acrylic polymer of the composition of the present invention is measured by thermogravimetric analysis using a TGA 2950 instrument supplied by TA Instruments of 109 Lukens Drive, New Castle, Del. 19720. Suitably, the TGA 2950 instrument is fitted with an evolved gas analysis (EGA) furnace Part No. 952351.901 obtainable from TA Instruments having a fully enclosed heating element. Suitably, the TGA 2950 instrument is calibrated for temperature using samples of alumel wire and nickel wire supplied by TA Instruments. Suitably, a single cylindrical shaped pellet of the acrylic polymer typically 10 to 20 mg having a length of 3 mm and cross-sectional diameter of 3 mm is placed on a platinum pan and loaded into the EGA furnace. Suitably, the TGA 2950 instrument is purged with nitrogen having a flow rate of 100 ml per minute, so that 10 percent of the flow is directed to the balance chamber and 90 percent of the flow is directed to the furnace. Suitably, the acrylic polymer is heated at a rate of 5° C. per minute from room temperature to a maximum of 600° C. and the weight of the particle measured with time. A plot is generated showing the decrease in weight of the acrylic polymer with increasing temperature of the acrylic polymer. Any weight loss from the acrylic polymer in the temperature range of room temperature to 135° C. is representative of moisture evaporating from the polymer and such values are not taken into consideration for determining the thermal degradation temperature. The thermal degradation temperature is the temperature at which the weight of the acrylic polymer decreases by greater than or equal to 1% based on the weight of the polymer measured at 135° C.

It will therefore be appreciated by those skilled in the art that the thermal degradation temperature of an acrylic polymer of the composition of the present invention as determined in accordance with the thermogravimetric analysis method disclosed herein is typically not affected by small quantities of moisture (approximately less than or equal to 0.3% by weight water) that may be present in the acrylic polymer.

Suitably, if the acrylic polymer has a thermal degradation temperature of less than or equal to 295° C. typically ensures that the thermal stability of the composition of the present invention is comparable to that of the unmodified polyester.

Suitably, the acrylic polymer has a thermal degradation temperature of greater than or equal to 270° C., more suitably greater than or equal to 272° C., preferably greater than or equal to 273° C., preferably greater than or equal to 275° C., more preferably greater than or equal to 278° C., preferably greater than or equal to 280° C., especially greater than 282° C.

Suitably, the acrylic polymer has a thermal degradation temperature of less than or equal to 295° C., preferably less than or equal to 294° C., preferably less than or equal to 293° C., more preferably less than or equal to 292° C., especially less than or equal to 290° C.

A particularly preferred thermal degradation temperature of the acrylic polymer is greater than or equal to 285° C. and less than or equal to 290° C., especially 286° C.

Suitably, the thermal degradation temperature is the temperature above 135° C. at which the acrylic polymer must be heated in accordance with the thermogravimetric procedures described herein, so that the weight of the acrylic polymer decreases by less than 2% by weight, preferably less than 1.7% by weight, preferably less than 1.5% by weight, preferably less than 1.3% by weight, preferably 1.1% by weight, especially 1% by weight based on the weight of the acrylic polymer measured at 135° C.

It will be appreciated by those skilled in the art that the thermal degradation temperature of the acrylic polymer is representative of the thermal stability of the acrylic polymer. Suitably, a higher thermal degradation temperature typically indicates a more thermally stable acrylic polymer.

Surprisingly, it has been found that the thermal stability of the composition of the invention, particularly at temperature ranges such as 280° C. to 310° C. used to process polyesters, typically increases with addition of an acrylic polymer having a thermal degradation temperature within the aforementioned ranges, rather than an acrylic polymer having a thermal degradation temperature in excess of 295° C. Suitably, one may expect that an acrylic polymer having a higher thermal degradation temperature e.g. greater than 295° C. would produce a more thermally stable polymeric mixture when added to a polyester, compared with an acrylic polymer having a lower thermal degradation temperature, e.g. less than or equal to 295° C. and preferably within the above defined ranges, particularly where the polymeric mixture is used to produce fibres typically at temperature ranges of 280° C. to 310° C. In fact, the opposite effect appears to exist.

Suitably, the amount of thermal degradation of an acrylic polymer heated at a specific temperature for a set period of time is also typically representative of the thermal stability of the polymer. Suitably, a larger decrease in the weight of a polymer at a specific temperature over a set time period typically indicates a less thermally stable polymer.

Suitably, the weight of the acrylic polymer of the composition of the present invention after heating at 295° C. for 1 hour decreases by greater than or equal to 10% by weight, suitably greater than or equal to 11% by weight, preferably less than or equal to 12% by weight, more preferably greater than or equal to 15% by weight based on the original weight of the acrylic polymer when initially measured at 295° C.

Suitably the weight of the acrylic polymer of the composition of the present invention after heating at 295° C. for 1 hour decreases by less than or equal to 20% by weight, preferably less than or equal to 18% by weight, more preferably less than or equal to 17% by weight, most preferably less than or equal to 16% by weight based on the original weight of the acrylic polymer when initially measured at 295° C.

Suitably, the amount of thermal degradation of a polymer heated at a specific temperature for a set period of time may be determined by thermogravimetric analysis using a TGA 2950 instrument and EGA furnace as described herein. Suitably, the TGA 2950 instrument is purged with nitrogen having a flow rate of 100 ml per minute, so that 10% of the flow is directed to the balance chamber and 90% of the flow is directed to the furnace. Suitably, a single cylindrical pellet of the polymer of known weight (typically 10 to 20 mg) having a length and cross-sectional diameter of 3 mm is placed on a platinum pan which is loaded into the EGA furnace. Suitably, the polymer is typically heated at 50° C./minute to a temperature of 295° C. Once the temperature has reached 295° C. the initial weight of the polymer is recorded. Heating at 295° C. is continued over a specific period, typically 1 hour, and the final weight of the polymer recorded. The difference between the final and initial weight of the polymer divided by the initial weight of the polymer expressed as a percentage provides a value of the decrease in % wt of the polymer based on the initial weight of the polymer measured at 295° C. (e.g. the amount of thermal degradation of the polymer).

Although, as mentioned above, the acrylic polymer of the present invention may exhibit greater than or equal to 10% weight loss when heated at 295° C. for 1 hour as determined in accordance with the thermogravimetric analysis method described herein, typically the weight of the composition of the present invention after heating at 295° C. for 1 hour, decreases by less than or equal to 0.4% by weight, preferably less than or equal to 0.35% by weight, preferably less than or equal to 0.3% by weight, more preferably less than or equal to 0.2% by weight, most preferably less than or equal to 1.5% by weight based on the original weight of the composition of the present invention when initially measured at 295° C.

Surprisingly, it has been found that the decrease in weight of the composition of the present invention due to thermal degradation typically decreases with increasing thermal instability of the acrylic polymer e.g. increasing chain end unsaturation and/or increasing weight loss of the acrylic polymer at 295° C.

Suitably, the composition of the present invention exhibits a thermal stability that is similar to that of the unmodified polyester not including the acrylic polymer. Moreover, a fibre formed from a composition of the present invention at a specific spinning speed typically exhibits a higher elongation of break than a fibre formed from the polyester alone at the same specific spinning speed. Suitably, the overall efficiency of a yarn producing process employing the composition of the present invention may be increased, as thermal degradation of the composition may be avoided or lessened during a fibre forming process.

Suitably, it has been found that the amount of chain end unsaturation of the acrylic polymer of the composition of the present invention is typically indicative of the thermal stability of the acrylic polymer. It is well known to those skilled in the art that the thermal stability of acrylic polymers, particularly at temperature ranges such as 280 to 310° C. used to process polyesters, decreases as the degree of chain end unsaturation increases [Kahiwagi et al. Macromolecules 19, 2160-2168 (1986)].

Surprisingly, it has been found that the thermal stability of the composition of the present invention typically increases with addition of an acrylic polymer additive having increased chain end unsaturation.

According to a second aspect, the present invention provides a composition comprising a polyester and an acrylic polymer, wherein the acrylic polymer has greater than or equal to 1.0% chain end unsaturation.

Such a composition is also referred to herein as a composition of the present invention.

Typically, the chain end unsaturation results from the termination of the polymeric chain by disproportionation reactions and is typified by the presence of a vinylidene group at the chain end. Consequently, one may expect that acrylic polymers exhibiting higher thermal stabilities would produce more thermally stable polymeric mixtures when added to a polyester compared with counterpart acrylic polymers exhibiting lower thermal stabilities. In other words, one may expect that acrylic polymers having lower degrees of chain end unsaturation compared with those having higher degrees of chain end unsaturation would produce more thermally stable polymeric mixtures. In fact the opposite effect appears to exist.

Such a composition is also referred to herein as the composition of the present invention.

By adding an acrylic polymer having preferably greater than or equal to 1% chain end unsaturation typically ensures that the thermal stability of the composition of the present invention is comparable to that of the unmodified polyester. More preferably, the acrylic polymer has greater than or equal to 1.2%, most preferably greater than or equal to 1.5%, especially greater than or equal to 2% chain end unsaturation. Preferably, the acrylic polymer has less than or equal to 20%, more preferably 15% or less, more preferably 12% or less, more preferably, 9% or less, most preferably 6% or less, especially 5% or less chain end unsaturation.

Suitably, the acrylic polymer is amorphous. Preferably, the acrylic polymer is substantially immiscible with the polyester. By the term “substantially immiscible” we include that at the spinning temperature, typically 280 to 310° C., the acrylic polymer forms a two-phase melt with the polyester. In other words, at the spinning temperature the polyester forms a molten matrix having molten acrylic additive polymer dispersed therein. Microscopic examination of such a melt shows a two phase system in which the immiscible acrylic polymer is in the form of droplets or globules, which may be of any shape, dispersed in the continuous polyester matrix. Typically, the droplets/globules are spherical, cylindrical and/or ellipsoidal in shape. Most preferably, the droplets/globules are spherical and/or ellipsoidal in shape. Suitably, the acrylic additive polymer is a separate entity than the polyester polymer.

As mentioned previously, the composition of the present invention may be formed into fibres by passing the molten composition through a spinneret and taking up the resultant fibres onto a winder. Typically, the additive in the free-fall fibre emerging from the spinneret before taken up onto a winder is in the form of droplets or globules. Most preferably, the droplets/globules of the additive do not form rod-shaped inclusions in the free-fall fibre. However, the form of the additive in the free-fall fibre may change when the fibre is taken up onto a winder. Suitably, when the fibre is taken up onto a winder the additive may form rod-shaped inclusions.

Preferably, the acrylic polymer does not include liquid crystal polymer i.e. it does remain in an anisotropic melt in the temperature range at which the composition of the present invention may be melt spun, e.g. 270° C. to 310° C., after a shear stress is removed.

Preferably, the acrylic polymer includes less then 2% by weight of a styrene polymer. More preferably, the acrylic polymer includes less than 1% by weight, most preferably less than 0.5% by weight, of a styrene polymer. Especially preferred acrylic polymers do not include any styrene polymer.

The acrylic polymer suitably includes homopolymers and copolymers (which term includes polymers having more than two different repeat units) comprising monomers of acrylic acid and/or alkacrylic acid and/or an alkyl (alk)acrylate. As used herein, the term “alkyl (alk)acrylate” refers to either the corresponding acrylate or alkacrylate ester, which are usually formed from the corresponding acrylic or alkacrylic acids, respectively. In other words, the term “alkyl (alk)acrylate” refers to either an alkyl alkacrylate or an alkyl acrylate.

Preferably, the alkyl (alk)acrylate is a (C₁-C₂₂)alkyl ((C₁-C₁₀)alk)acrylate. Examples of C₁-C₂₂ alkyl groups of the alkyl (alk)acrylates include methyl, ethyl, n-propyl, n-butyl, iso-butyl, tert-butyl, iso-propyl, pentyl, hexyl, cyclohexyl, 2-ethyl hexyl, heptyl, octyl, nonyl, decyl, isodecyl, undecyl, dodecyl, tridecyl, tetradecyl, pentadecyl, hexadecyl, heptadecyl, octadecyl, nonadecyl, eicosyl, behenyl, and isomers thereof. The alkyl group may be straight or branched chain. Preferably, the (C₁-C₂₂)alkyl group represents a (C₁-C₆)alkyl group as defined above, more preferably a (C₁-C₄)alkyl group as defined above. Examples of C₁₋₁₀ alk groups of the alkyl (alk)acrylate include methyl, ethyl, n-propyl, iso-propyl, n-butyl, iso-butyl, tert-butyl, pentyl, hexyl, cyclohexyl, 2-ethyl hexyl, heptyl, octyl, nonyl, decyl and isomers thereof. The alk groups may be straight or branched chain. Preferably, the (C₁-C₁₀)alk group represents a (C₁-C₆)alk group as defined above, more preferably a (C₁-C₄) alk group as defined above.

Preferably, the alkyl (alk)acrylate is a (C₁-C₄)alkyl ((C₁-C₄) alk)acrylate, most preferably a (C₁-C₄)alkyl (meth)acrylate. It will be appreciated that the term (C₁-C₄)alkyl (meth)acrylate refers to either (C₁-C₄)alkyl acrylate or (C₁-C₄)alkyl methacrylate. Examples of (C₁-C₄)alkyl (meth)acrylate include methyl methacrylate (MMA), ethyl methacrylate (EMA), n-propyl methacrylate (PMA), isopropyl methacrylate (IPMA), n-butyl methacrylate (BMA), isobutyl methacrylate (IBMA), tert-butyl methacrylate (TBMA): methyl acrylate (MA), ethyl acrylate (EA), n-propyl acrylate (PA), n-butyl acrylate (BA), isopropyl acrylate (IPA), isobutyl acrylate (IBA), and combinations thereof.

Preferably, the alkacrylic acid monomer is a (C₁-C₁₀)alkacrylic acid. Examples of (C₁-C₁₀)alkacrylic acids include methacrylic acid, ethacrylic acid, n-propacrylic acid, iso-propacrylic acid, n-butacrylic acid, iso-butacrylic acid, tert-butacrylic acid, pentacrylic acid, hexacrylic acid, heptacrylic acid and isomers thereof. Preferably the (C₁-C₁₀)alkacrylic acid is a (C₁-C₄)alkacrylic acid, most preferably methacrylic acid.

Preferably, the acrylic polymer is an acrylic copolymer. Preferably, the acrylic copolymer comprises monomers derived from alkyl (alk)acrylate, and/or acrylic acid and/or alkacrylic acid as defined hereinbefore. Most preferably, the acrylic copolymer comprises monomers derived from alkyl (alk)acrylate, i.e. copolymerisable alkyl acrylate and alkyl alkacrylate monomers as defined hereinbefore. Especially preferred acrylic copolymers include a (C₁-C₄)alkyl acrylate monomer and a copolymerisable (C₁-C₄)alkyl (C₁-C₄)alkacrylate comonomer, particularly copolymers formed from methyl methacrylate and a copolymerisable comonomer of methyl acrylate and/or ethyl acrylate and/or n-butyl acrylate.

Preferably, the acrylic polymer comprises greater than or, equal to 80 wt %, more preferably greater than or equal to 85 wt %, more preferably greater than or equal to 90 wt %, more preferably greater than or equal to 95 wt %, especially greater than or equal to 97 wt % methyl methacrylate based on the total weight of the acrylic polymer.

Preferably, the acrylic polymer comprises less than or equal to 20 wt %, more preferably less than or equal to 15 wt %, more preferably less than or equal to 10 wt %, more preferably less than or equal to 5 wt %, especially less than or equal to 3 wt % of an alkyl (alk)acrylate, as defined hereinbefore, based on the total weight of the acrylic polymer. Preferably the alkyl(alk)acrylate is an alkyl acrylate, particularly a (C₁-C₄)alkyl acrylate, as defined hereinbefore. Most preferably, the alkyl (alk)acrylate is ethyl acrylate and/or butyl acrylate and isomers thereof.

Preferably, the acrylic copolymer comprises a homopolymer or copolymer derived from a monomer mixture comprising 80 to 100 wt % of methyl methacrylate, 0 to 20 wt % of at least one other copolymerisable alkyl (alk)acrylate comonomer, 0 to 0.5 wt % of an initiator, and 0 to 1.0 wt % of a chain transfer agent.

Preferably, where the acrylic polymer is an acrylic copolymer, particularly an acrylic copolymer of methyl methacrylate, the acrylic polymer comprises a single copolymerisable alkyl acrylate as defined hereinbefore, especially ethyl acrylate or butyl acrylate and isomers thereof.

Preferably, the acrylic copolymer comprises 0.1 to 20% by weight of an alkyl acrylate as defined hereinbefore and 80 to 99% by weight of an alkyl alkacrylate, particularly methyl methacrylate, as defined hereinbefore. More preferably, the acrylic copolymer comprises 1 to 15% by weight of an alkyl acrylate and 85 to 99% by weight of an alkyl alkacrylate. More preferably, the acrylic copolymer comprises 1 to 10% by weight of an alkyl acrylate and 90 to 99% by weight of an alkyl alkacrylate. Especially preferred acrylic copolymers comprise 1 to 5% by weight of an alkyl acrylate as defined hereinbefore and 95 to 99% by weight of an alkyl alkacrylate, particularly methyl methacrylate.

Suitably, where the acrylic polymer is a copolymer derived from a monomer mixture of at least one alkyl alkacrylate as defined hereinbefore, particularly methyl methacrylate, and at least one other copolymerisable alkyl acrylate comonomer as defined hereinbefore, particularly ethyl and/or butyl acrylate, the ratio of the weight of alkyl alkacrylate to the weight of alkyl acrylate in the acrylic copolymer is suitably greater than or equal to 4:1, preferably greater than or equal to 5:1, preferably greater than or equal to 6:1, preferably greater than or equal to 8:1, preferably greater than or equal to 10:1, more preferably greater than or equal to 15:1, more preferably greater than or equal to 19:1.

Especially preferred acrylate copolymers include 1.0%, 1.75%, 2%, 3% and 5% by weight of an alkyl acrylate as defined hereinbefore, particularly methyl acrylate and/or ethyl acrylate and/or n-butyl acrylate, and 99.0%, 98.25%, 98%, 97% and 95% by weight respectively, of an alkyl alkacrylate as defined hereinbefore, particularly methyl methacrylate.

Preferably, the acrylic polymer has a weight average molecular weight greater than 50,000, more preferably greater than 75,000, most preferably greater than 85,000. Preferably the acrylic polymer has a weight average molecular weight less than 300,000, preferably less than 200,000, more preferably less than 125,000, most preferably less than 100,000. An acrylic polymer having a weight average molecular weight of approximately 90,000 is especially preferred. Suitably, the weight average molecular weight of the acrylic polymer may be measured by techniques well known to those skilled in the art, such as gel permeation chromatography. The acrylic polymer may be synthesised by techniques well known to those skilled in the art, such as suspension polymerisation as outlined in Kirk-Othmer Encyclopaedia of Chemical Technology, John Wiley and Sons. Vol. 16 p.506-537, particularly p.525-727.

Suitably, the suspension polymerisation method involves the polymerisation of one or more monomers of acrylic acid, alkacrylic acid or alkyl (alk)acrylate as defined hereinbefore in the presence of one or more initiators and one or more chain transfer agents.

Suitable initiators include free radical initiators such as peroxy, hydroperoxy and azo initiators, for example, 2,2′-azo-bis(isobutyronitrile) (AIBN), 2,2′-azo-bis(2,4-dimethylvaleronitrile), azo-bis(α-methylbutyronitrile), acetyl peroxide, dodecyl peroxide, benzoyl peroxide. Preferably, the acrylic polymer includes at least 0.01 wt %, more preferably at least 0.02 wt %, most preferably at least 0.04 wt % initiator based on the total weight of the acrylic polymer. Preferably, the acrylic polymer includes less than 0.5 wt %, more preferably less than 0.3 wt %, most preferably less than 0.25 wt % initiator based on the total weight of the acrylic polymer.

Suitably, chain transfer agents include thiols, such as dodecyl mercaptan, n-propyl mercaptan, n-butyl mercaptan, t-butyl mercaptan, 2-ethyl hexyl thioglycollate, thiophenol and butanthiol. Preferably, the acrylic polymer includes at least 0.03 wt %, preferably at least 0.05 wt %, preferably at least 0.8 wt %, preferably at least 0.1 wt %, most preferably at least 0.15 wt % chain transfer agent based on the total weight of the acrylic polymer. Preferably, the acrylic polymer includes less than 1 wt %, preferably less than 0.9 wt %, preferably less than 0.8 wt %, preferably less than 0.7 wt %, preferably less than 0.6 wt %, most preferably less than 0.5 wt % chain transfer agent based on the total weight of the acrylic polymer.

Suitably, it has been found that when the acrylic polymer of the present invention is prepared by suspension polymerisation, the molar ratio of the initiator to the chain transfer agent employed in the polymerisation process typically effects the thermal degradation temperature and/or the thermal stability and/or the amount of chain end unsaturation of the acrylic polymer.

Preferably, the molar ratio of initiator to chain transfer agent employed in the polymerisation process is less than or equal to 11:1, preferably less than or equal to 8:1, preferably less than or equal to 7:1, more preferably less than or equal to 6:1, more preferably less than or equal to 5:1, most preferably less than or equal to 4:1.

Preferably, the molar ratio of chain transfer agent to initiator employed in the polymerisation process is preferably greater than or equal to 1:1, preferably greater than or equal to 1.5:1, more preferably greater than or equal to 2:1.

An especially preferred range of the molar ratio of chain transfer agent to initiator employed in the polymerisation process is greater than or equal to 1:1 and less than or equal to 2.5:1.

Suitably, the acrylic polymer may include the aforementioned molar ratios of initiator to change transfer agents.

Suitably, an acrylic polymer having the desired degradation temperature and/or thermal stability and/or amount of chain end unsaturation, as defined hereinbefore, may be produced in a suspension polymerisation method employing the above mentioned molar ratios of chain transfer agent to initiator.

The degree of chain end unsaturation can be readily determined by the method disclosed in Kahiwagi et al, Macromolecules 19, 2160-2168 (1986).

Suitably, the polyester is thermoplastically processable and has a fibre forming property.

Preferably the polyester has a residue of an aromatic dicarboxylic acid as the main acid component. Preferably, the main acid component is terephthalic acid, phthalic acid, isophthalic acid, naphthalene dicarboxylic acid, such as napthlane-2,6-dicarboxylic acid, naphthalene-2,7-dicarboxylic acid and naphthalene-1,5-dicarboxylic, and diphenoxyethane dicarboxylic acids, such as 4,4′-diphenoxyethane dicarboxylic acid. The aromatic dicarboxylic acid may be substituted by preferably a (C₁-C₄)alkyl group, such as methyl, ethyl, n-propyl, iso-propyl, n-butyl, iso-butyl, and tert-butyl. In other words, we include methyl terephthalic acid and methyl isophthalic acid. Preferably, the polyester has an aliphatic or alicyclic diol as the main alcohol component. Preferably, the main alcohol component is trimethylene glycol, tetramethylene glycol, hexamethylene glycol, neopentyl glycol, ethylene glycol, 1,4-cyclohexane dimenthanol. Preferably, the polyester is a poly(Cₗ-C₄)alkylene terephthalate or poly (C₁-C₄)alkylene naphthalate. For example, we include polyethylene terephthalate (PET), polyethylene naphthalate, polypropylene terephthalate, polybutylene terephthalate, polytetramethylene terephthalate, poly-cyclohexane-dimethylene terephthalate, polytetramethylene terephthalate. The polyester may be a homopolymer or a copolymer. The homopolymers are preferred. However, polymers of these polyesters with other conventional monomers, such as diethylene glycol, isophthalic acid and/or adipic acid are also possible. Furthermore, mixtures of two or more of these polyesters may be used. Among these polyesters, polyethylene terephthalate (PET) is especially preferred.

Preferably, the polyester has an intrinsic viscosity measured at 25° C. in 8% o-chlorophenol of at least 0.4, more preferably at least 0.5. Preferably, the polyester has an intrinsic viscosity of less than 1.1 measured at 25° C. in 8% o-chlorophenol.

The polyester may comprise one or more additives selected from a delustering agent, a thermal stabilizer, an ultraviolet absorber, an antistatic agent, a terminating agent and a fluorescent whitening agent, or a mixture of two or more of these additives.

Preferably, the acrylic polymer as defined hereinbefore is added to the polyester in an amount of at least 0.05 wt %, more preferably at least 0.1 wt %, and most preferably at least 0.2 wt % of the polyester. Preferably, the acrylic polymer is added to the polyester in an amount of less than or equal to 10 wt %, more preferably less than or equal to 5 wt %, and most preferably less than or equal to 2.5 wt % of the polyester. The addition of such low amounts may further reduce the costs of the overall process, thereby allowing significant increases in productivity to be achieved.

Preferably, the amount of acrylic polymer in the composition of the present invention is at least 0.05 wt %, more preferably at least 0.1 wt %, most preferably at least 0.2 wt % based on the total weight of the composition of the present invention.

Preferably, the amount of acrylic polymer in the composition of the present invention is less than or equal to 10 wt %, preferably less than or equal to 5 wt %, more preferably less than or equal to 2.5 wt % based on the total weight of the composition of the present invention.

Preferably, the amount of polyester in the composition of the present invention is greater than or equal to 90 wt %, preferably greater than or equal to 95 wt %, more preferably greater than or equal to 97.5 wt % based on the total weight of the composition of the present invention.

Preferably, the amount of polyester in the composition of the present invention is less than 99.95 wt %, more preferably less than 99.9 wt %, most preferably less than 99.8 wt % based on the total weight of the composition of the present invention.

Suitably, the physical form of the composition of the present invention should be substantially the same as the form of polymer alone. Preferably, the composition of the present invention and the polymer alone comprises a cylindrical pellet, preferably the cylindrical pellet has a cross-sectional diameter of greater than or equal to 0.1 mm and less than or equal to 3 mm, and a length of less than or equal to 3 mm. A cylindrical pellet having a length of 3 mm and a cross-sectional diameter of 3 mm is especially preferred.

The acrylic polymer may be incorporated into the polyester by various methods. For example, the addition of the acrylic polymer may be effected during the polymerisation, process for forming the polyester. Alternatively, the acrylic polymer may be compounded with the polyester to form a pellet which may be subsequently extruded at temperatures of between 270° C. and 310° C. and spun into a yarn. Furthermore, the acrylic polymer may be mixed with the polyester in the hopper of an extruder and the resultant mixture may be extruded at temperatures of between 270° C. and 310° C. and spun into a yarn. Alternatively, a melt stream of the acrylic polymer may be added to a melt stream of the polyester by a side extrusion or injection process.

Most preferably, non-molten acrylic polymer is added to a melt stream of the polyester (e.g. at a temperature of approximately 290° C.) by a cramming process. By adding non-molten acrylic polymer to such a melt stream, enables the composition of the present invention to be easily controlled and/or varied during the production process. The adaptability of the production equipment may result in significant cost savings and enhanced productivity, particularly if it is necessary to vary the composition of the present invention. Moreover, this type of addition process may minimise the exposure of the acrylic polymer to the high temperature polyester processing conditions, thereby forming a more stable polymer mixture.

According to a further aspect, the present invention provides a process for making a composition of the present invention comprising providing a polyester as defined herein and adding an acrylic polymer as defined herein to the polyester. Preferably, non-molten acrylic polymer is added to molten polyester.

According to a further aspect, the present invention provides a process for producing a polymeric fibre comprising providing a molten composition of the present invention as defined herein, and forming a fibre from the molten composition of the present invention.

Preferably, the molten composition of the present invention is formed by adding non-molten acrylic polymer as defined herein to molten polyester.

The non-molten acrylic polymer may be added at various points in the spin line. If the spin line does not include an extruder, i.e. the molten polyester is fed to a set of static and/or dynamic mixers upstream of a spinneret by booster pumps, then preferably the non-molten acrylic polymer is added to the molten polyester stream at a point immediately before the molten polyester reaches the static and/or dynamic mixers. Suitably, such a point of addition minimises the exposure of the acrylic polymer to the high temperature polymer processing conditions whilst enabling the acrylic polymer to be adequately mixed with the molten polymer.

It will be appreciated that the non-molten acrylic polymer may be added to the molten polyester stream at any point between the booster pumps and the static and/or dynamic mixers. Alternatively, the non-molten acrylic polymer may be added to the molten polyester stream in the booster pumps or at a point-upstream of the booster pumps, i.e. at a point before the polymer stream reaches the booster pumps.

If the spin line includes an extruder, as opposed to booster pumps, then the non-molten acrylic polymer may be added to the screw section of the extruder. Alternatively, the non-molten acrylic polymer may be added immediately downstream of the extruder i.e. at or just beyond the tip of the screw, so that pressure carries the acrylic polymer forward with the molten polyester stream. Alternatively, the non-molten acrylic polymer may be added downstream of the extruder at a point immediately prior to the molten polyester stream reaching a set of static mixers and/or dynamic mixers. Such a point of addition may further minimise the exposure of the acrylic polymer to the high temperature processing conditions e.g. 270° C. to 310° C. Preferably, the non-molten acrylic polymer is added to the screw section of the extruder. Most preferably, at a point of the screw section of the extruder where the polyester melts in the extruder. Such a point of addition usually ensures that the acrylic polymer is subjected to adequate shear forces so that droplets form prior to emerging from the spinneret whilst minimising the exposure of the acrylic polymer additive to the high temperature processing conditions, typically 270° C. to 310° C.

Preferably, the non-molten acrylic polymer is added to the molten polyester by a crammer such as a twin-screw crammer, model ZS-B25, supplied by Werner & Pfleiderer or a twin-screw crammer, model R17, supplied by Stöber.

It will be appreciated by those skilled in the art that various combinations of the above points of addition for adding the non-molten acrylic polymer to the polyester melt are embraced by the present invention. Moreover, the non-molten acrylic polymer may be replaced totally or partially by a molten acrylic polymer.

The acrylic polymer is preferably homogeneously distributed in the molten polyester by mixing in the extruder and/or by means of the static and/or dynamic mixers in the distribution manifold and/or in the spin pack to form a molten polyester matrix having the acrylic polymer additive dispersed therein. Suitably, varying the point of addition of the acrylic polymer enables the user to vary the type and extent of mixing of the acrylic polymer with the molten polyester. Suitably, this enables the user to vary the rheology of the acrylic polymer and thereby control the particle size distribution of the acrylic polymer in the composition of the present invention before the composition of the present invention passes through the spinneret.

It is believed that the optimum droplet size of the additive in the polymer matrix should have a maximum dimension of between 50 and 400 nm.

Suitably, the additive in the composition of the present invention has a maximum cross-sectional dimension of less than or equal to 400 nm, more preferably less than or equal to 300 nm. Suitably, the additive in the composition of the present invention has a maximum cross-sectional dimension of greater than or equal to 50 nm, more preferably greater than or equal to 75 nm. A particularly preferred maximum cross-sectional dimension of the additive in the composition of the present invention is 200 nm.

Suitably, the size of the additive acrylic polymer fed to the hopper is larger than the size of additive that emerges from the die of the extruder and/or the spinneret.

The size of the additive in the composition of the present invention, such as its cross-sectional dimension, may be measured by techniques well known to those skilled in the art, for example, by scanning or transmission electron microscopy. In scanning electron microscopy, the composition of the present invention is frozen, typically in liquid nitrogen, and then fractured to expose the additive material whose size is measured by an electron microscope. In transmission electron microscopy, the composition of the present invention is frozen, typically in liquid nitrogen, and then pieces are shaved off for analysis with an electron microscope.

Preferably, the production of the polymeric fibre is accomplished by high speed spinning using spinning devices which are known per se. Preferably, spinning speeds of greater than or equal to 500 m/minute, more preferably greater than or equal to 2000 m/minute, most preferably 3000 m/minute are employed. Preferably, the spinning speed is less than or equal to 10000 m/minute, more preferably less than or equal to 7500 m/minute, most preferably less than or equal to 6000 m/minute.

According to yet a further aspect the invention provides a fibre comprising an acrylic polymer as defined herein. Preferably, the fibre further includes a polyester as defined hereinbefore.

According to a further aspect, the present invention provides the use of an acrylic polymer as defined herein or use of the composition of the present invention for forming a fibre.

According to yet a further aspect, the present invention provides an acrylic polymer as defined herein.

According to yet a further aspect, the present invention provides a method of forming an acrylic polymer as defined herein. Preferably, the acrylic polymer is formed by suspension polymerisation.

The invention will be further described by way of the following non-limiting examples with reference to the accompanying drawings, wherein:

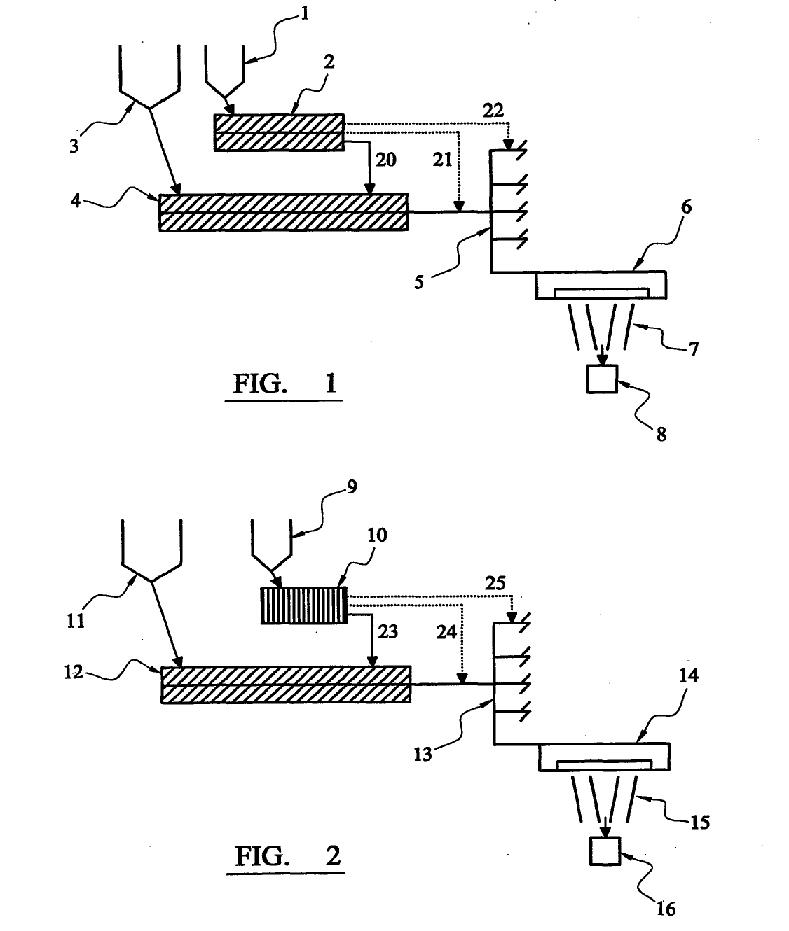

FIG. 1 is a flow diagram representing a spin line for producing a polymeric fibre by incorporating molten acrylic polymer into a melt stream of a polyester; and

FIG. 2 is a flow diagram representing a spin line for producing a polymeric fibre by incorporating non-molten acrylic polymer into a melt stream of a polyester.

There is shown in FIG. 1 apparatus for adding molten acrylic polymer to a melt stream of polyester comprising a hopper (1) for receiving the acrylic polymer and an extruder (2) for extruding the acrylic polymer from the hopper (1). The apparatus further comprises a separate hopper (3) for receiving the polyester polymer and an extruder (4) for extruding the polyester polymer from the hopper (3). The extruder (4) feeds into a tubular manifold system (5) containing static mixers. The tubular manifold system (5) feeds into a spin pack and spinneret (6). The spinneret comprises a plate having typically more than 20 holes each having a diameter of about 0.3 mm.

In use, the hoppers (1) and (3) are charged with dry base chips (typically cylindrical chips of length 3 mm and cross-sectional diameter of 3 mm) of the acrylic polymer and polyester polymer, respectively. The extruders (2) and (4) extrude the acrylic polymer and polyester from the hoppers (1 and 2) to form separate melt flows of the two polymers at temperatures of between 270° C. and 310° C. The molten acrylic polymer is added to the melt flow of the polyester polymer. This may take place in the screw of the extruder (4) as indicated by line 20, and/or at a point immediately downstream of the extruder (i.e. at or just beyond the tip of the screw) as indicated by line 21, and/or at a point immediately upstream of the static mixers as indicated by line 22. It will be appreciated that a combination of the above points of addition may be employed. Moreover, the molten acrylic polymer may be added to the molten polyester polymer at any point along the manifold system (5) before the pack and spinneret (6). The polymer mixture is mixed by the static mixers of the manifold system (5) and then metered to the spin pack and spinneret (6). The spin pack is filled with shattered metal and produces very high shear so that filaments (7) of the polymeric mixture emerge from the spinneret. The filaments (7) are forwarded to an appropriate take-up station (8) well known to those skilled in the art which may include various finishing and packaging steps.

There is shown in FIG. 2 apparatus for adding non-molten acrylic polymer (typically cylindrical chips of length 3 mm and cross-sectional diameter of 3 mm or beads produced by suspension polymerisation having an average particle size of 200 to 900 nm when measured by a sieve) to a melt stream of a polyester polymer comprising a hopper (11) for receiving the polyester polymer and an extruder (12) for forming a melt stream of the polyester polymer. The extruder (12) terminates in a tubular manifold (13) having static mixers contained therein. The tubular manifold (13) feeds into a spin pack and spinneret (14) as described above for the apparatus of FIG. 1. The apparatus further comprises a separate hopper (9) for receiving the acrylic polymer and a crammer (10), such as that supplied by Stöber, for delivering non-molten acrylic polymer to the polyester melt flow.

In use, the hoppers (11) and (9) are charged with dry base chips of polyester polymer and acrylic polymer respectively. The extruder (12) extrudes the polyester polymer from the hopper (11) to produce a melt flow. The crammer (10) conveys the non-molten acrylic polymer into the polyester melt stream. The crammer does not include a separate heat source so that it does not melt the acrylic polymer. Optionally, the crammer may include a cooling apparatus. The non-molten acrylic polymer may be added to the screw of the extruder (12) as indicated by line 23, and/or at a point immediately downstream of the extruder (i.e. at or just beyond the tip of the screw) as indicated by line 24, and/or at a point immediately upstream of the static mixers in the tubular manifold (13) as indicated by line 25. In general, the non-molten acrylic polymer can be added at any point along the tubular manifold system (13) before the spin pack and spinneret (14). If the acrylic polymer is added to the screw of the extruder (12) then preferably the additive crammer (10) is situated opposite an additive injector, if one fitted. As before, the filaments (15) are forwarded to an appropriate take-up system (16) which may include various finishing and packaging steps.

It will be appreciated by those skilled in the art that one or all of the extruders (4 and 12) of the apparatus of FIGS. 1 and 2 may be replaced by booster pumps, if the system is fed with a polyester melt, for example from a continuous polymerisation process. Suitably, the crammer may be replaced by a volumetric or gravimetric feeder.

The following examples demonstrate that polymeric fibres formed by the process of the present invention not only possess a higher elongation at break in the strand at a particular spinning speed compared to polyester itself, but also exhibit a thermal stability similar to the unmodified polyester. This leads to an overall increase in the productivity of the spinning process.

In the following examples the elongation at break of a fibre was determined using an Instron tensile tester equipped with a load cell of 5 kg capacity, which was calibrated to a chart recorder to give a maximum of 2 kg load at 200 mm on the paper. Ten samples of each yarn were tested. Individual samples of each yarn were mounted in card squares with a test length of 200 mm. The mounted samples were conditioned for 24 hours and 65% relative humidity. The chart recorder was set at a speed of 5 mm/second. The samples were presented manually to the jaws of the tensile tester to ensure sufficient grip. Both edges of the cardboard mount were carefully cut and the test completed at a cross head speed of 20 mm/minute. The percentage elongation at break was measured directly from the experimental stress-strain curves.

### EXAMPLE 1

Polyethylene terephthalate was dried in vacuo at 150° C. for 8 hours [Fibre Grade available from Akzo] and subsequently melted in a single-screw extruder. The melt was fed at a temperature of 295° C. through a manifold containing Sulzer (Zurich, Switzerland) model SMX static mixing elements and empty pipe sections to a gear metering pump. This fed the spinneret which had 24 nozzles each of diameter 0.35 mm.

The strands emerging from the bores of the die plate were cooled with air in a conventional quench duct before being bundled by means of an oiler pin and provided with a spinning oil-water emulsion.

The thread bundle was drawn off by means of two driven godets entwined in an s-shaped form and wound on empty bobbins to yarn packages in a Barmag (Remscheid, Germany) winding unit to produce a 120 dernier fibre.

The take-off speed was adjusted to 2500 m/minute. The data are summarised in Table 1.

TABLE 1

| | Experiment |
|---|---|
| | 1 |
| % Elongation at break | 175 |

### EXAMPLE 2

Polyethylene terephthalate (as used in Example 1 above) was dried in vacuo at 150° C. for 8 hours and spun as in Example 1 to produce a 120 dernier fibre, but at a take-up speed of 3250 m/minute. The data are summarised in Table 2.

TABLE 2

| | Experiment |
|---|---|
| | 2 |
| % Elongation at break | 120 |

### EXAMPLE 3

Preparation of an acrylate copolymer additive of the present invention comprising 98.25% by weight methyl methacrylate and 1.75% by weight ethyl acrylate by suspension polymerisation.

A 5 litre round bottom flask with four baffles in the flask walls and equipped with a shaft driven paddle stirrer passing down an alembic condenser is charged with 28 g disodium hydrogen phosphate dihydrate, 2000 g deionised water, and 100 g of 1% sodium polymethacrylate (highs molecular weight polymethylacrylate, neutralised with NaOH) solution in water. The suspension is heated to 40° C. to 50° C. with stirring to dissolve the sodium polymethacrylate, and nitrogen is bubbled through the solution for 30 minutes to remove oxygen. The nitrogen purge is stopped and 1080 g methyl methacrylate, 19.25 g ethyl acrylate, 2.50 g 2,2′-azobis(isobutyronitrile) (AIBN) and 3.40 g dodecyl mercaptan are then charged to the reaction flask. A nitrogen blanket is maintained over the reactants. The reaction mixture is heated to a reflux temperature of ˜82° C. and maintained while the reaction proceeds. The stirrer speed may need to be increased during the reaction exotherm which can push the temperature up to ca. 95° C. and water may need to be added if the bath foams excessively. After the exotherm begins to subside the bath is heat-treated to reduce residual monomer levels and decompose any residual initiator by heating at 90° C. for 1 hour. The reaction mixture is cooled and then centrifugally washed by pouring the reaction slurry into a centrifuge bag, dewatering and washing with 2×2 litres deionised water, with dewatering between each addition. The centrifuge bags have a pore size of ca. 75 microns. The filtered and washed polymer is spread onto trays and dried in an air oven at a temperature of 75° C. for 24 hours, to yield the title acrylate copolymer having a weight average molecular weight of 98,000 measured by gel permeation chromatography.

The acrylate copolymer had a melt flow index MFI (ASTM D1238, 230° C., 3.8 kg) of 2.3 g/10 minutes, a viscosity number 56 ccm/g (measured as a 0.5% solution in chloroform) and 12.03% chain end unsaturation as measured using the method of Kahiwagi et al as referenced hereinbefore.

### EXAMPLE 4

The acrylate copolymer of Example 3 is compounded into pellets using a BC21 co-rotating twin screw extruder by Clextral, fitted with a general purpose screw, running at 230° C. with a screw speed of 250 revolutions per minute and an output of 10 kg/hour. The respective acrylate copolymer pellets thus formed are compounded with polyethylene terephthalate pellets (Fibre Grade available from Akzo) at a level of 1% by weight using a 2SK 30 co-rotating twin screw extruder by Werner Pfleiderer, fitted with a screw suitable for processing PET or nylon, running at 270° C. with a screw speed of 275 revolutions per minute and an output of 15 kg/hour from the extruder. The resultant composition in pelletised form is dried in vacuo at 150° C. for 8 hours and then fed into the single screw extruder and spin line of Example 1. This melt blend was spun as in Example 1. Materials were collected at wind up speed of 2500 m/minute to produce a 120 dernier fibre. The data are summarised in Table 3.

TABLE 3

Experiment

| | 1 | 3 |
|---|---|---|
| % Elongation at break | 175 | 220 |

The results demonstrate that a polymeric fibre formed from the composition of the present invention exhibits a higher elongation at break in the strand compared to unmodified polyester.

### EXAMPLE 5

The acrylate copolymer of Example 3 is compounded into pellets using a BC21 co-rotating twin screw extruder by Clextral, fitted with a general purpose screw, running at 230° C. with a screw speed of 250 revolutions per minute and an output of 10 kg/hour. The respective acrylate copolymer pellets thus formed are compounded with polyethylene terephthalate pellets (Fibre Grade available from Akzo) at a level of 1% by weight using a 2SK 30 co-rotating twin screw extruder by Werner Pfleiderer, fitted with a screw suitable for processing PET or nylon, running at 270° C. with a screw speed of 275 revolutions per minute and an output of 15 kg/hour from the extruder. The resultant composition in pelletised form is dried in vacuo at 150° C. for 8 hours and then fed into the single screw extruder and spin line of Example 1. This melt blend was spun as in Example 2. Materials were collected at wind up speed of 3250 m/minute to produce a 120 dernier fibre. The data are summarised in Table 4.

TABLE 4

Experiment

| | 2 | 4 |
|---|---|---|
| % Elongation at break | 120 | 170 |

The results demonstrate that a polymeric fibre formed from the composition of the present invention exhibit a higher elongation at break in the strand compared to unmodified polyester.

### EXAMPLE 6

Preparation of a comparative acrylate copolymer additive comprising 99.5% by weight methyl methacrylate and 0.5% by weight ethyl acrylate by bag polymerisation.

The following materials were thoroughly mixed in a 10 litre glass round bottomed flask using a shaft driven paddle stirrer passing down an alembic chamber.

4923.30 g methyl methacrylate

24.70 g ethyl acrylate

2.40 g lauryl peroxide

0.54 g t-butyl peroxyacetate (50% active)

23.09 g dodecyl mercaptan

0.73 g oxalic acid solution (7.16% w/w in water)

0.91 g 75% w/w sodium dioctyl sulphosuccinate in ethanol/water (AOT 75)

4.95 g dithio-bis-stearylpropionate

19.80 g stearyl methacrylate

The reaction mixture is stirred and the flask purged with nitrogen for 30 minutes. The monomer mixtures produced are charged into a nylon 6,6 (or nylon 6) polymer bag having a wall thickness less than 0.8 mm for polymerisation. The bag is similar in appearance to a plastic trash bag with dimensions sufficient to accommodate the monomer mixture and yield a bag thickness of no more than 3 cm. The bag is placed on a metal tray and filled with the monomer mixture. Trapped air is removed and the bag sealed with a metal clip. The tray and bag are placed in a suitably designed oven and the oven temperature controlled as detailed in the table below:

| Step | Temperature | Time | |
|---|---|---|---|
| 1 | 63° C. | 1.5 | h |
| 2 | 58° C. | 13.5 | h |
| 3 | 62° C. | 1 | h |
| 4 | 65° C. | 2 | h |
| 5 | 75° C. | 1 | h |
| 6 | 100° C. | 1 | h |
| 7 | 130° C. | 2 | h |

This profile achieved a conversion level of >98% and produced a bulk polymer of very smooth appearance with no irregularities or “hot spots” at the surface. The nylon bag was removed to yield the title acrylate copolymer having a weight average molecular weight of 77,000 as measured by gel permeation chromatography.

The acrylate polymer thus produced was determined to have a melt flow index MFI (ASTM D1238, 230° C., 3.8 kg) of 3.4 g/10 minute and 0.39% chain end unsaturation using the method of Kahiwagi et al.

### EXAMPLE 7

Preparation of an acrylate copolymer additive of the present invention comprising 98.0% by weight methyl methacrylate and 2.0% by weight ethyl acrylate by suspension polymerisation.

A 5 litre round bottom flask with four baffles in the flask walls and equipped with a shaft driven paddle stirrer passing down an alembic condenser is charged with 28 g disodium hydrogen phosphate dihydrate, 2000 g deionised water, and 100 g of 1% sodium polymethacrylate (high molecular weight polymethylacrylate, neutralised with NaOH) solution in water. The suspension is heated to 40° C. to 50° C. with stirring to dissolve the sodium polymethacrylate, and nitrogen is bubbled through the solution for 30 minutes to remove oxygen. The nitrogen purge is stopped and 1080 g methyl methacrylate, 22 g ethyl acrylate, 0.6 g 2,2′-azobis(isobutyronitrile) (AIBN) and 3.60 g dodecyl mercaptan are then charged to the reaction flask. A nitrogen blanket is maintained over the reactants. The reaction mixture is heated to the reflux temperature of ˜82° C. and maintained while the reaction proceeds. The stirrer speed may need to be increased during the reaction exotherm which can push the temperature up to ca. 92° C. and water may need to be added if the batch foams excessively. After the exotherm begins to subside the bath is heat-treated to reduce residual monomer levels and decompose any residual initiator by heating at 90° C. for 1 hour. The reaction mixture is cooled and then centrifugally washed by pouring the reaction slurry into a centrifuge bag, dewatering and washing with 2×2 litres deionised water, with dewatering between each addition. The centrifuge bags have a pore size of ca. 75 microns. The filtered and washed polymer is spread onto trays and dried in an air oven at a temperature of 75° C. for 24 hours, to yield the title acrylate copolymer having a weight average molecular weight of 95,000 as measured by gel permeation chromatography.

The acrylate polymer thus produced was determined to have a melt flow index MFI (ASTM D1238, 230° C., 3.8 kg) of 3.0 g/10 minutes and 1.18% chain end unsaturation using the method of Kahiwagi et al.

### EXAMPLE 8

General Procedure for Determining the Degradation Temperature and the Weight Loss of a Polymer at 295° C.

The degradation temperature and weight loss of a polymer is measured by thermogravimetric analysis using TGA 2950 instrument obtainable from TA Instruments. The TGA 2950 instrument is fitted with an evolved gas analysis (EGA) furnace that offers the advantage of a fully enclosed heating element. The TGA 290 instrument has the advantage that a thermocouple is located within the sample chamber adjacent to the sample. As a result the measured temperature is a true reflection of the sample rather than the furnace temperature value. Nitrogen gas is purged through the instrument at a flow rate of 100 ml per minute, so that the flow distribution is 10% to the balance chamber and 90% to the furnace. The transfer line from the EGA furnace is vented into an extraction hood.

The instrument is calibrated for temperature using samples of alumel wire (PIN 952398.901) and nickel wire (PIN 952385.901) supplied by TA Instruments. The values obtained were 154.16° C. for the alumel wire and 368.23° C. for the nickel wire. These results are input as Points 1 and 2 respectively in the temperature calibration menu of the instrument along with standard temperatures quoted for various materials in the TA Instruments calibration literature. The instrument is set in TGA 1000° C. mode and the data sampling imterval set to 2 sec/point.

Platinum pans of 100 μl capacity for holding the polymer samples are used for all measurements. The pans are cleaned prior to use by heating them to a red heat for a minimum of 5 seconds, or until all combustible material had been removed, using a blow torch. The cleaned pans are always baselined using the instruments Tare function before use to ensure only the weight of the polymer sample is recorded.

Degradation Temperature of an Acrylic Polymer

A single pellet of an acrylic polymer (approximate weight (10 to 20 mg) that is cylindrical in shape being approximately 3 mm long and 3 mm cross-sectional diameter is placed on a clean platinum pan and loaded into the EGA furnace.

The acrylic polymer is heated at a rate of 5° C./minute to a maximum temperature of 600° C. The instrument records the weight of the acrylic polymer as function of time. Analysis of a weight versus temperature plot allows derivation of the amount of moisture present in the sample, corresponding to the amount of weight lost when the sample is heated from room temperature to 135° C. The temperature above 135° C. at which the acrylic polymer loses a further 1% of its weight, corresponds to the thermal degradation temperature of the polymer referred to as Td(1%). In other words, the temperature above 135° C. at which the acrylic polymer must be heated so that the weight of the acrylic polymer as measured at 135° C. decreases by greater than or equal to 1% by weight due to thermal degradation.

Weight Loss of a Polymer at 295° C.

A single pellet of polymeric material (approximately 10 to 25 mg in weight) that is cylindrical in shape being approximately 3 mm long and 3 mm cross-sectional diameter is dried in vacuo at 150° C. for 8 hours, then it is placed on a clean platinum pan and loaded into the EGA furnace.

The dried pellet is heated from ambient temperature at a rate of 50° C. per minute under a nitrogen atmosphere to a temperature of 150° C. The temperature is maintained at 150° C. for 1 hour to ensure all moisture is removed from the pellet. The pellet is then heated at a rate of 50° C. per minute under nitrogen to a temperature of 295° C. Upon reaching 295° C., the weight of the pellet (initial weight) is recorded and heating continued for 1 hour. After 1 hour the weight of the pellet (final weight) is recorded.

The difference between the final and initial weight of the pellet is divided by the initial weight of the pellet expressed as a percentage to provide a value of the decrease in % by weight of the polymer based on the initial weight of the polymer measured at 295° C.

### EXAMPLE 9

Weight Loss from Polyethylene Terephthalate at 295° C.

The weight loss from a cylindrical pellet of polyethylene terephthalate (Fibre Grade available from Akzo) (10 to 25 mg) having an approximate length of 3 mm and cross-sectional diameter of 3 mm was determined at 295° C. for 1 hour in accordance with the method described in Example 8 above.

After exposing the polyethylene terephthalate to a temperature of 295° C. for 1 hour the material had lost 0.28% of its initial weight.

### EXAMPLE 10

The weight loss at 295° C. over a 1 hour period and the degradation temperature of various acrylic polymers (approximate weight of bead is 10 to 25 mg) was determined in accordance with the procedure of Example 8. The results are displayed in Table 5 below, where

Sample A—is an acrylate homopolymer Delpet 80N, a polymethyl methacrylate, supplied by Asahi and is evaluated for comparative purposes.

Sample B—is an acrylate copolymer Degalan G8E, supplied by Degussa and is evaluated for comparative purposes.

Sample C—is the comparative acrylate copolymer additive comprising 99.5% by weight methyl methacrylate and 0.5% by weight ethyl acrylate prepared as in Example 6.

Sample D—is the acrylate copolymer additive comprising 98.0% by weight methyl methacrylate and 2.0% by weight ethyl acrylate as prepared in Example 7.

Sample E—is the acrylate copolymer additive comprising 98.25% by weight methyl methacrylate and 1.75% by weight ethyl acrylate as prepared in Example 3.

The materials were chosen to represent a range of chain end unsaturations, while possessing inherently similar viscosities under PET processing conditions. Chain end unsaturation was evaluated under a nitrogen atmosphere using methods as developed by following Kahiwagi et al.

TABLE 5

| | | | | MFI | Weight |
|---|---|---|---|---|---|
| | | | | (ASTM | loss at |
| | Viscosity | T_{d} | | D1238) | 295° C. |
| | Number/ | (1%) | % Chain end | g/10 | after 1 |
| Sample | ccm/g | ° C. | unsaturation | minutes | h/% wt |
| A | 61 | 297 | 0.32 | 2.0 | 7.69 |
| B | 297 | 0.80 | | | |
| C | 59 | 298 | 0.39 | 3.4 | 3.86 |
| D | 60 | 278 | 1.18 | 3.0 | 14.63 |
| E | 56 | 286 | 12.03 | 2.3 | 15.94 |

The results demonstrate that the acrylic polymers of the present invention have lower thermal degradation temperatures, increased chain end unsaturation and exhibit greater weight loss at 295° C. over 1 hour compared to the comparative acrylic polymers.

### EXAMPLE 11

The weights loss at 295° C. over a 1 hour period was evaluated for the following compositions (approximate weight of bead is 10 to 25 mg) using the method of Example 8 above.

| Sample | Composition |
|---|---|
| F | 99% wt polyethylene terephthalate: 1% wt of |
| | comparative acrylate copolymer of Example 6 |
| | comprising 99.5% by weight methyl methacrylate |
| | and 0.5% by weight ethyl acrylate. |
| G | 99% wt polyethylene terephthalate: 1% wt |
| | acrylate copolymer of Example 7 comprising |
| | 98.0% by weight methyl methacrylate and 2.0% |
| | by weight ethyl acrylate. |
| H | 99% wt polyethylene terephthalate: 1% wt |
| | acrylate copolymer of Example 3 comprising |
| | 98.25% by weight methyl methacrylate and 1.75% |
| | by weight ethyl acrylate. |

Each of the compositions are produced by compounding the respective acrylate copolymer into pellets using a BC21 co-rotating twin screw extruder by Clextral, fitted with a general purpose screw, running at 230° C. with a screw speed of 250 revolutions per minute and an output of 10 kg/hour. The respective acrylate copolymer pellets thus formed are compounded with polyethylene terephthalate pellets (Fibre Grade available from Akzo) at a level of 1% by weight using a 2SK 30 co-rotating twin screw extruder by Werner Pfleiderer, fitted with a screw suitable for processing PET or nylon, running at 270° C. with a screw speed of 275 revolutions per minute and an output of 15 kg/hour from the extruder.

The results obtained are displayed in Table 6

TABLE 6

| | % acrylic chain end | Weight loss after 1 |
|---|---|---|
| Sample | unsaturation | hour/% wt |
| F | 0.39 | 0.52 |
| G | 1.18 | 0.38 |
| H | 12.03 | 0.31 |
| PET | — | 0.28 |

The results demonstrate that a more thermally stable polyethylene terephthalate (PET)/acrylate copolymer blend is formed by employing an acrylate copolymer of lower thermal stability having increased chain end unsaturation.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A composition comprising a polyester and an acrylic polymer, wherein the acrylic polymer has a thermal degradation temperature of less than or equal to 295° C.

2. A composition as claimed in claim 1 wherein the acrylic polymer has greater than or equal to 1.0% chain end unsaturation.

3. A composition comprising a polyester and an acrylic polymer, wherein the acrylic polymer has greater than or equal to 1.0% chain end unsaturation.

4. A composition as claimed in any one of the preceding claims wherein the acrylic polymer has a thermal degradation temperature of greater than or equal to 270° C.

5. A composition as claimed in any one of the preceding claims wherein the weight of the acrylic polymer after heating at 295° C. for 1 hour decreases by greater than or equal to 10% by weight based on the original weight of the acrylic polymer as measured initially at 295° C.

6. A composition as claimed in any one of the preceding claims wherein the weight of the composition after heating at 295° C. for 1 hour decreases by less than or equal to 0.4% by weight based on the original weight of the composition as measured initially at 295° C.

7. A composition as claimed in any one of the preceding claims wherein the acrylic polymer has less than or equal to 20% chain end unsaturation.

8. A composition as claimed in any one of the preceding claims wherein the polyester comprises polyethylene terephthalate.

9. A composition as claimed in any one of the preceding claims wherein the acrylic polymer comprises a homopolymer or copolymer derived from a monomer mixture comprising 80 to 100 wt % of methyl methacrylate, 0 to 20 wt % of at least one other copolymerisable alkyl (alk)acrylate comonomer, 0 to 0.5 wt % of an initiator, and 0 to 1.0 wt % of a chain transfer agent.

10. A composition as claimed in claim 9 wherein the acrylic polymer is derived from a monomer mixture comprising at least 85 wt % methyl methacrylate.

11. A composition as claimed in claim 9 or 10 wherein the acrylic polymer is derived from a monomer mixture comprising of a copolymerisable alkyl (alk)acrylate monomer.

12. A composition as claimed in any one of claims 9 to 11 wherein the copolymerisable alkyl (alk)acrylate comonomer is an alkXl acrylate.

13. A composition as claimed in any of claims 9 to 11 wherein the acrylic polymer includes from 0.05 wt % to 0.25 wt % of initiator.

14. A composition as claimed in any one of claims 9 to 12 wherein the acrylic polymer includes from 0.05 wt % to 0.5 wt % chain transfer agent.

15. A composition as claimed in any one of the preceding claims wherein the acrylic polymer is an acrylic copolymer.

16. A composition as claimed in any one of the preceding claims wherein the composition comprises at least 0.05% by weight of said acrylic polymer.

17. A composition as claimed in any one of the preceding claims wherein the acrylic polymer has a weight average molecular weight of greater than 50,000 and less than 200,000.

18. A composition as claimed in any one of the preceding claims wherein the composition is molten.

19. A process for making a composition as claimed in any one of claims 1 to 18 comprising providing a polyester and adding an acrylic polymer as defined in any one of claims 1 to 18 to the polyester.

20. A process as claimed in claim 19 wherein non-molten acrylic polymer is added to molten polyester.

21. An acrylic polymer as defined in any one of claims 1 to 18.

22. A process for producing a polymeric fibre comprising providing a molten composition as defined in any one of claims 1 to 18 and producing a fibre from the molten composition.

23. A process as claimed in claim 22 wherein the molten composition is produced by forming a melt of the polyester and adding non-molten acrylic polymer to the polyester.

24. A process as claimed in claim 23 wherein the polyester melt is fed to a mixer, the non-molten acrylic polymer is added to the polyester melt at a point upstream of the mixer to form the molten composition, mixing the molten composition, and producing a fibre from the molten composition.

25. A process as claimed in claim 24 wherein the polyester melt is formed by extruding the polyester and the non-molten acrylic polymer is added to the polyester melt in the extruder and/or at a point downstream of the extruder and upstream of the mixer.

26. A process as claimed in claim 23 wherein the polyester melt is formed by extruding the polyester and the non-molten acrylic polymer is added to the polyester melt in the extruder and/or at a point downstream of the extruder.

27. Use of an acrylic polymer as defined in any one of claims 1 to 18 for forming a fibre.

28. A fibre comprising the composition as defined in any one of claims 1 to 18.

29. Use of a composition as defined in any one of claims 1 to 18 for forming a fibre.
